(19) United States
(12) Patent Application Publication
(10) Pub. No.: US 2020/0125850 A1
(43) Pub. Date: Apr. 23, 2020

(54) INFORMATION PROVIDING SYSTEM, INFORMATION PROVIDING METHOD, AND PROGRAM

(71) Applicant: HONDA MOTOR CO., LTD., Minato-ku,Tokyo (JP)

(72) Inventors: Yuji Yasui, Wako-shi (JP); Kentaro Ishisaka, Wako-shi (JP); Nobuyuki Watanabe, Wako-shi (JP); Kovi Ahego, Wako-shi (JP); Christopher Lang, Wako-shi (JP); Liyan Liu, Tokyo (JP); Yo Ito, Tokyo (JP); Hirotaka Uchitomi, Tokyo (JP)

(21) Appl. No.: 16/621,995

(22) PCT Filed: Jun. 14, 2018
(86) PCT No.: PCT/JP2018/022740

§ 371 Date: Dec. 12, 2019

(30) Foreign Application Priority Data
Jun. 16, 2017 (JP) 2017-118693

(51) Int. Cl. G06K 9/00; G06T 19/00; G01C 21/36

(52) U.S. Cl. CPC G06K 9/00671; G01C 21/3676; G06T 19/006

(57) ABSTRACT

An information providing system includes an imager, a display which displays an image captured by the imager, an identifier which analyzes the image captured by the imager and identifies event types indicated by semantic information included in the image, and a display controller which causes the display to display an image corresponding to a predetermined event type from among the event types identified by the identifier.

### TECHNICAL FIELD

The present invention relates to an information providing system, an information providing method, and a program.

Priority is claimed on Japanese Patent Application No. 2017-118693, filed Jun. 16, 2017, the content of which is incorporated herein by reference.

### BACKGROUND ART

Conventionally, a technique of changing imaged road signs to road signs of native countries and displaying the changed road signs when road signs included in images captured by a camera are displayed to users and travel areas of vehicles are not the native countries of drivers has been disclosed (refer to Patent Literature 1, for example).

### CITATION LIST

### Patent Literature

### [Patent Literature 1]

Japanese Unexamined Patent Application, First Publication No. 2009-109404

### SUMMARY OF INVENTION

### Technical Problem

However, in the conventional technique, there are cases in which not only are imaged road signs displayed by changing to road signs of a native country directly associated therewith but also unnecessary information is converted and displayed to a user. Accordingly, the user may also need to check information that does not need to be understood and thus a burden during perception increases and information that users want to see may be missed. An object of the present invention devised in view of the aforementioned circumstances is to provide an information providing system, an information providing method, and a program which can reduce a burden during perception of a user.

### Solution to Problem

An information providing system, an information providing method, and a program according to the present invention employ the following configurations.

(1): An information providing system according to one aspect of the present invention includes: an imager (130); a display (140) which displays an image captured by the imager; an identifier (122) which analyzes the image captured by the imager and identifies event types indicated by semantic information included in the image; and a display controller (124) which causes the display to display an image corresponding to a predetermined event type from among the event types identified by the identifier.

(2): In the aspect of (1), the information providing system further includes a receiver (140) which receives an input operation of a user, and the display controller causes the display to display an image corresponding to an event type input to the receiver from among the event types identified by the identifier.

(3): In the aspect of (1) or (2), the image corresponding to the event type is an image representing the event type without depending on text information.

(4): In any one of the aspects of (1) to (3), the display controller causes the display to display the image corresponding to the predetermined event type in association with a position at which the semantic information is displayed.

(5): In any one of the aspects of (1) to (4), the information providing system further includes a receiver which receives an input operation of a user, and the display controller controls the display to display detailed information of an event identified by the identifier according to an operation performed through the receiver in response to display of the image through the display.

(6): In the aspect of (5), the display controller translates the detailed information of the event identified by the identifier into a language set by a user and causes the display to display the translated information.

(7): In any one of the aspects of (1) to (6), the display controller causes the display to emphasize and display a part of the image corresponding to an event type set by the user.

(8): An information providing method according to one aspect of the present invention includes, using a computer: displaying an image captured by an imager on a display; analyzing the image captured by the imager and identifying event types indicated by semantic information included in the image; and displaying an image corresponding to a predetermined event type from among the identified event types on a display.

(9): A program according to one aspect of the present invention causes a computer: to display an image captured by an imager on a display; to analyze the image captured by the imager and identify event types indicated by semantic information included in the image; and to cause the display to display an image corresponding to a predetermined event type from among the identified event types.

### Advantageous Effects of Invention

According to (1), (8) or (9), the information providing system can reduce a burden during perception of a user.

According to (2), the information providing system can display an image corresponding to an event type set by a user. Accordingly, the user can rapidly check information that the user wants to see without missing it.

According to (3), a user can rapidly ascertain an event type from an image.

According to (4), a user can easily ascertain which semantic information is associated with an image corresponding to an event type.

According to (5), the information providing system can provide detailed information associated with an image corresponding to an event type to a user according to an operation performed on the image to a user. Accordingly, the user can ascertain details of semantic information associated with the image.

According to (6), a user can easily ascertain details of semantic information on the basis of detailed information translation results even when the user does not know the language of the semantic information.

According to (7), a user can easily ascertain a position at which semantic information corresponding to an event type set by the user is displayed.

### BRIEF DESCRIPTION OF DRAWINGS

FIG. 1 is a diagram showing an example of a configuration of an information providing system of a first embodiment.

FIG. 2 is a diagram showing functional components of an application executer and an overview of an information provision service provided by cooperation with a server device.

FIG. 3 is a diagram showing an example of a setting screen of the first embodiment.

FIG. 4 is a diagram showing examples of logos.

FIG. 5 is a diagram showing another example of a setting screen of the first embodiment.

FIG. 6 is a diagram showing an example of details of setting information.

FIG. 7 is a diagram showing an example of details of a logo acquisition table.

FIG. 8 is a diagram showing a state in which logos are overlaid and displayed on a through image.

FIG. 9 is a diagram showing an example of details of a detailed information DB.

FIG. 10 is a diagram showing a state in which detailed information is displayed.

FIG. 11 is a diagram showing a state in which a translation result is displayed.

FIG. 12 is a flowchart showing an example of a flow of information providing processing of the first embodiment.

FIG. 13 is a diagram showing an example of a configuration of an information providing system of a second embodiment.

FIG. 14 is a diagram showing an example of a setting screen of the second embodiment.

FIG. 15 is a diagram showing an example of display of route information.

FIG. 16 is a diagram showing an example of display of a route information translation result.

FIG. 17 is a diagram showing an example of a configuration of an information providing system of a third embodiment.

FIG. 18 shows an example of a through image of a menu of dishes of a restaurant captured by a terminal device.

FIG. 19 is a diagram showing an example of a through image of signboards captured from a vehicle traveling on a road.

FIG. 20 is a diagram showing an example of a structure for distributing incentives in a system to which an information providing system is applied.

### DESCRIPTION OF EMBODIMENTS

Hereinafter, an information providing system, an information providing method, and a program of the present invention will be described with reference to the drawings.

### First Embodiment

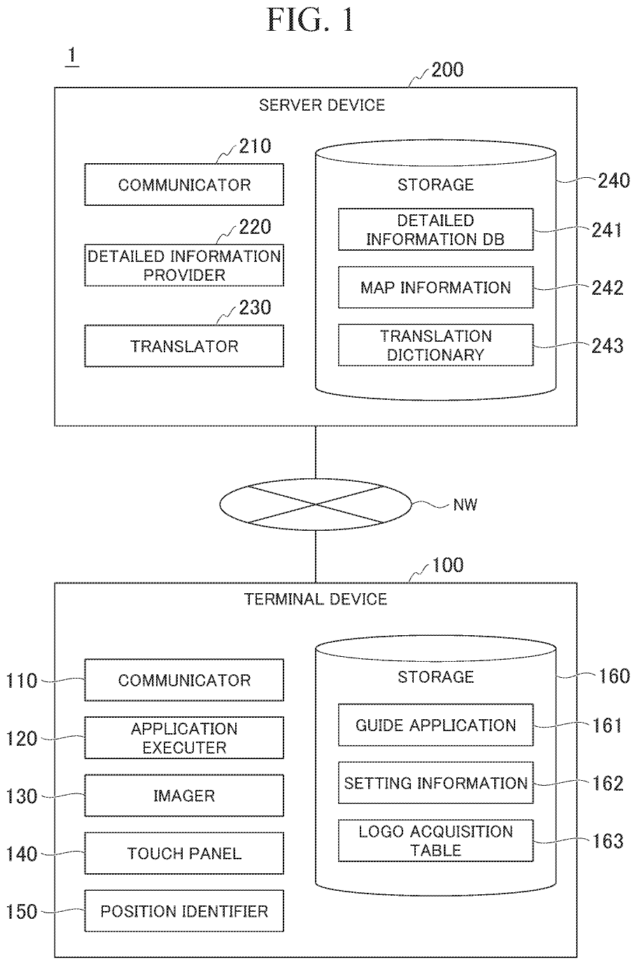

FIG. 1 is a diagram showing an example of a configuration of an information providing system 1 of a first embodiment. The information providing system 1 includes, for example, at least one terminal device 100 and a server device 200. The terminal device 100 and the server device 200 perform communication with each other through a network NW. The network NW includes, for example, a wireless base station, a Wi-Fi access point, a communication line, a provider, the Internet, and the like.

The terminal device 100 is, for example, a portable terminal device such as a smartphone or a table terminal.

The terminal device 100 includes, for example, a communicator 110, an application executer 120, an imager 130, a touch panel 140, a position identifier 150, and a storage 160. The application executer 120 and the position identifier 150 are realized by a hardware processor such as a central processing unit (CPU) executing programs (software). In addition, one or both of the application executer 120 and the position identifier 150 may be realized by hardware such as a large scale integration (LSI) circuit, an application specific integrated circuit (ASIC) and a field-programmable gate array (FPGA) or realized by software and hardware in cooperation. Programs may be stored in advance in a storage device (e.g., the storage 160) such as a hard disk drive (HDD) or flash memory or stored in a detachable storage medium such as a DVD or a CD-ROM and installed in a storage device when the storage medium is inserted into a drive device (not shown). Further, the touch panel 140 may be a combination of a “display” and a “receiver” integrated into one body.

The communicator 110 communicates with the server device 200 through the network NW. The communicator 110 is, for example, a communication interface such as a wireless communication module.

The application executer 120 is realized by execution of a guide application 161 stored in the storage 160. The guide application 161 is, for example, an application program for identifying event types represented by semantic information included in an image captured by the imager 130 and causing the touch panel 140 to display an image corresponding to an event type set by a user from among the identified event types. Particularly, the application executer 120 identifies event types represented by semantic information included in a through image captured by the imager 130 and performs the aforementioned processing. A through image is an image obtained by acquiring a photoelectric conversion result of an image sensor as streaming data and displayed to a user as a video before a shutter is pressed.

The application executer 120 selects a still image from a through image at any timing and causes the touch panel 140 to display an image corresponding to an event type set by a user for the still image. Semantic information is information (pixel distribution) of which a meaning can be ascertained according to image analysis, such as text, marks and icons.

In the first embodiment, semantic information is, for example, information about guide indication indicating a destination which is a specific place or information about information display related to that place. An event represents a classification result obtained by classifying semantic information into broad categories. For example, as events in an airport, concepts such as a boarding gate, a bus terminal, a train terminal, a restaurant and toilets correspond to “events.” Functions of the application executer 120 will be described in detail later.

The imager 130 is, for example, a digital camera using a solid-state imaging device (image sensor) such as a charge coupled device (CCD) or a complementary metal oxide semiconductor (CMOS). The imager 130 acquires a through image based on a photoelectric conversion result of an image sensor and controls opening and closing of a shutter to capture a still image.

The touch panel 140 is a liquid crystal display (LCD) or an organic electroluminescence (EL) display device and has a function of displaying images and a function of detecting a position of a finger of a user on a display surface.

The position identifier 150 identifies the position of the terminal device 100. The position identifier 150 identifies the position (e.g., latitude, longitude and altitude) of the terminal device 100, for example, on the basis of signals received from global navigation satellite system (GNSS) satellites. In addition, the position identifier 150 may identify the position of the terminal device 100 on the basis of the position of a wireless base station, a radio wave intensity, and the like.

The storage 160 is realized by a read only memory (ROM), a random access memory (RAM), a flash memory or the like. The storage 160 stores, for example, the guide application 161, setting information 162, a logo acquisition table 163, and other types of information. The setting information 162 is, for example, information indicating an event and a translation language selected by a user. The logo acquisition table 163 is information for converting an event acquired from semantic information included in a captured image of the imager 130 into a logo. The setting information 162 and the logo acquisition table 163 will be described in detail later.

The server device 200 includes, for example, a communicator 210, a detailed information provider 220, a translator 230, and a storage 240. The detailed information provider 220 and the translator 230 are realized by a hardware processor such as a CPU executing programs. In addition, one or both of the detailed information provider 220 and the translator 230 may be realized by hardware such as an LSI circuit, an ASIC and an FPGA or realized by software and hardware in cooperation. Programs may be stored in advance in a storage device (e.g., the storage 240) such as an HDD or a flash memory or stored in a detachable storage medium such as a DVD or a CD-ROM and installed in a storage device when the storage medium is inserted into a drive device (not shown).

The communicator 210 communicates with the terminal device 100 through the network NW. The communicator 210 is, for example, a communication interface such as a network interface card (NIC).

The detailed information provider 220 transmits detailed information to the terminal device 100 in response to a detailed information acquisition request from the terminal device 100 received by the communicator 210. The detailed information provider 220 will be described in detail later.

The translator 230 performs translation with reference to a translation dictionary 243 in response to a translation request from the terminal device 100 and transmits a translation result to the terminal device 100.

The storage 240 is realized by a ROM, a RAM, an HDD, a flash memory or the like. The storage 240 stores, for example, detailed information DB 241, map information 242, the translation dictionary 243 and other types of information. The detailed information DB 241 is a database in which specific explanation related to logos corresponding to semantic information is stored. A specific example of the detailed information DB 241 will be described later.

The map information 242 is, for example, maps of predetermined facilities such as airport premises and station premises. In addition, the map information 242 may include information about route maps and time tables of trains, fares of respective route sections, and travel times. Further, the map information 242 may include road information and building information associated with map coordinates. Building information includes the names, addresses, telephone numbers and the like of stores and facilities in buildings. The translation dictionary 243 includes words or sentences necessary to perform translation between a plurality of languages.

### [Information Provision Service According to Cooperation of Application Executer 120 and Server Device 200]

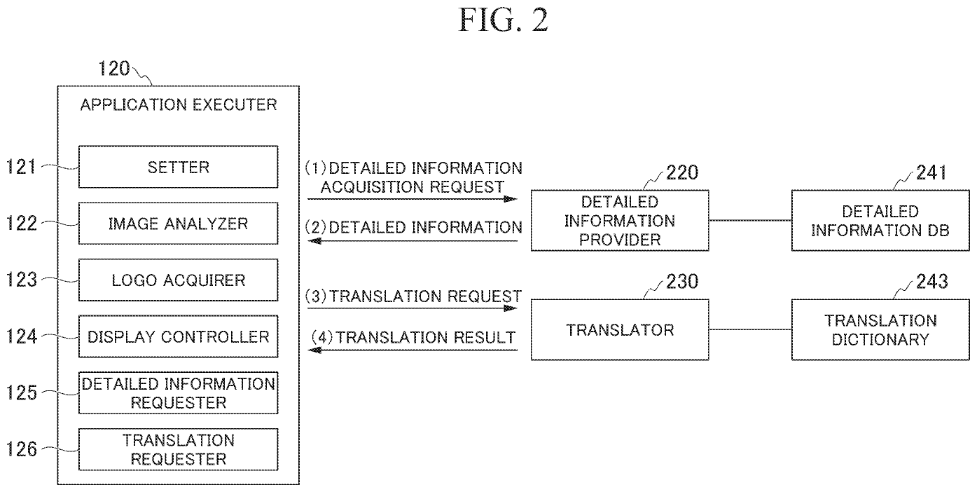

Next, an information provision service according to cooperation of the application executer 120 and the server device 200 will be described. FIG. 2 is a diagram showing functional components of the application executer 120 and an overview of an information provision service provided by cooperation with the server device 200.

For example, the terminal device 100 may start the guide application 161 when an input operation from a user is received for an image for starting the guide application 161 displayed on the touch panel 140. Accordingly, the application executer 120 starts to operate.

The application executer 120 includes, for example, a setter 121, an image analyzer 122, a logo acquirer 123, a display controller 124, a detailed information requester 125, and a translation requester 126. The image analyzer 122 is an example of an “identifier.” In addition, a combination of the logo acquirer 123 and the display controller 124 is an example of a “display controller.”

The setter 121 causes the touch panel 140 to display a GUI switch for displaying a setting screen through which user settings are set, and when a user performs selection, controls the touch panel 140 such that it displays the setting screen.

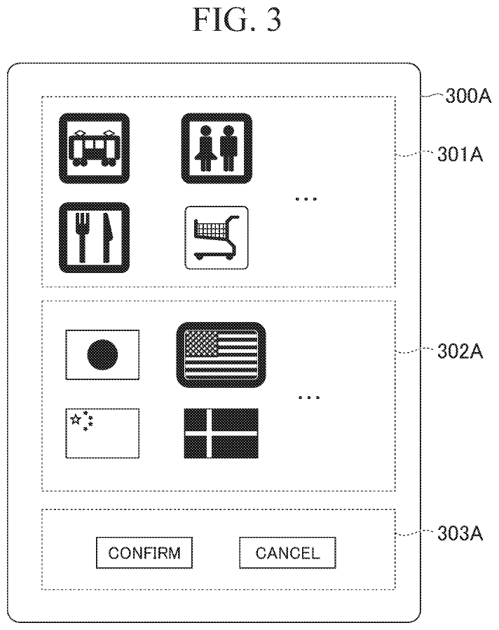

FIG. 3 is a diagram showing an example of a setting screen of the first embodiment. The setting screen 300A displays a logo display type selection area 301A through which a logo type to be displayed on a screen is selected, a translation language selection area 302A through which a translation language is selected, and a confirmation operation area 303A through which set details are confirmed or cancelled. Logos are associated with events one to one or one to many and schematically represent details of events.

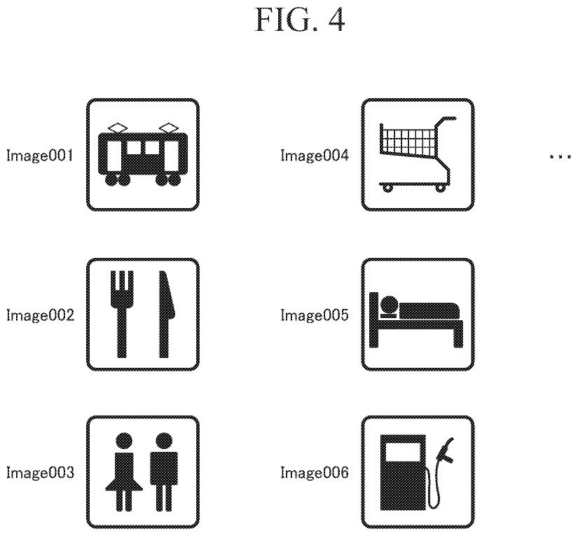

FIG. 4 is a diagram showing examples of logos. A logo is, for example, an image representing an event type as a schematic mark, sign or the like that is easily understood by a user and represents an event without depending on text information. Further, a logo may be an image which is standardized worldwide. Identification information (e.g., “Image001” or the like) for identifying a logo is associated with each logo.

For example, a user may check a logo corresponding to an event desired to be displayed from among various logos displayed in the logo display type selection area 301A. In addition, the user may select a logo using a translation language that the user can understand from among logos such as national flags. FIG. 3 shows an example in which logos related to traffic, eating and toilet have been selected in the logo display type selection area 301A and English has been selected as a translation language in the translation language selection area 302A. Accordingly, a user can select guide information and a translation language to be displayed on a screen simply using logos without reading wording.

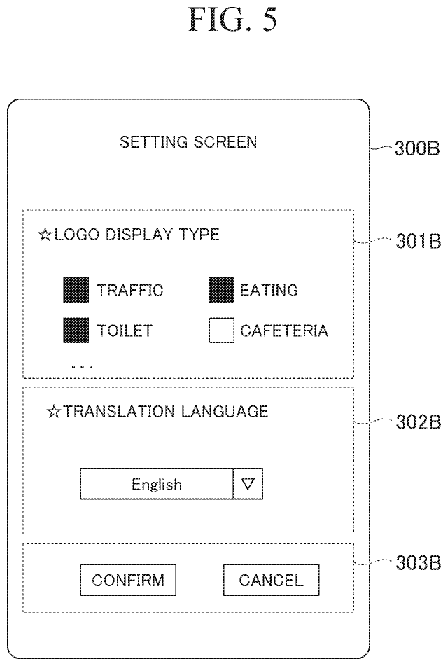

FIG. 5 is a diagram showing another example of a setting screen of the first embodiment. A setting screen 300B displays a logo display type selection area 301B, a translation language selection area 302B and a confirmation operation area 303B. The setting screen 300B shown in FIG. 5 displays character information instead of logos in contrast to the setting screen 300A.

For example, a user may check a check box of a logo corresponding to an event desired to be displayed from among types displayed in the logo display type selection area 301B. Further, the user may select a translation language that the user can understand from a plurality of languages displayed in a drop-down list. In the example of FIG. 5, traffic, eating and toilet have been selected in the logo display type selection area 301B and English has been selected as a translation language in the translation language selection area 302A. Meanwhile, the setter 121 may display a screen through which a language of characters to be displayed is set before the setting screen 300B is displayed and display the setting screen 300B using character information translated into a language set by the user. Further, the setting screens 300A and 300B shown in FIG. 3 and FIG. 5 may incorporate some information displayed on other setting screens.

When the user selects the confirmation button displayed in the confirmation operation areas 303A and 303B, the setter 121 stores information received through the setting screens 300A and 300B in the storage 160 as setting information 162.

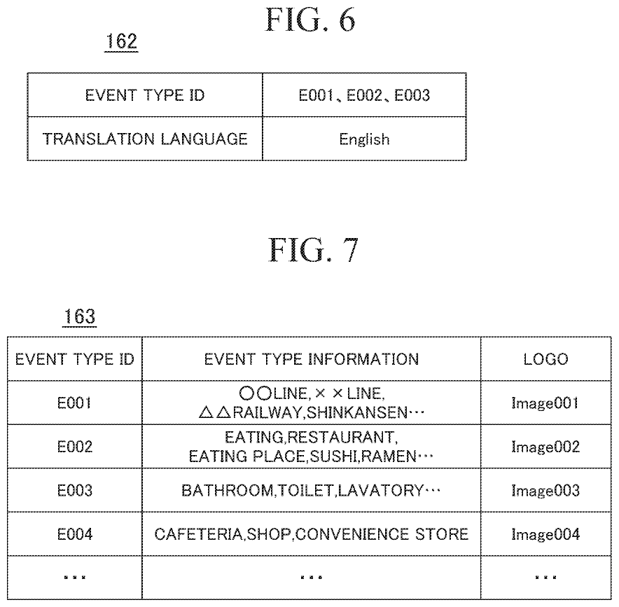

FIG. 6 is a diagram showing an example of details of the setting information 162. The setting information 162 stores event type IDs which are identification information of event types corresponding to logos selected through the logo display type selection areas 301A and 301B of the setting screens 300A and 300B, and a translation language selected through the translation language selection areas 302A and 302B. The application executer 120 performs the following processing according to an operation of a user in a state in which the aforementioned setting information 162 is stored in the storage 160.

The image analyzer 122 analyzes a through image of the imager 130 and recognizes details of text and signs of guide indications included in the through image through optical character recognition (OCR) or the like. In addition, the image analyzer 122 may perform segmentation processing on the through image of the imager 130. The segmentation processing is, for example, processing of extracting a partial image in which signboards, signs and other objects are displayed from the through image or converting a partial image into a two-dimensional image.

The logo acquirer 123 refers to the logo acquisition table 163 on the basis of an analysis result of the image analyzer 122 and acquires an event type ID and a logo corresponding to the analysis result. In addition, the logo acquirer 123 may acquire event main information and the like with reference to an external device such as a trademark database on the basis of a partial image extracted by the image analyzer 122 in addition to or instead of logo acquisition processing using the logo acquisition table 163. In this case, the logo acquirer 123 may generate or update the logo acquisition table 163 using the acquired organizer information and the like.

FIG. 7 is a diagram showing an example of details of the logo acquisition table 163. In the logo acquisition table 163, event type information and logos are associated with event type IDs which are identification information for identifying event types. Event type information is, for example, information such as text, a mark, and an icon predetermined for each classified event.

The logo acquirer 123 acquires an event type ID including event type information matching an analysis result acquired by the image analyzer 122 and a logo associated with the event type ID with reference to the event type information of the logo acquisition table 163. Matching may include a case of different words having the same meaning (e.g., “RAAMEN” for “RAMEN” and the like) in addition to perfect matching and partial matching.

In addition, the logo acquirer 123 determines whether a logo acquired by the logo acquisition table 163 corresponds to a predetermined event type. For example, the logo acquirer 123 may refer to the setting information 162 on the basis of an event type ID acquired along with a logo, and when the event type ID matches an event type ID included in the setting information 162, determine that the logo corresponds to a predetermined event type.

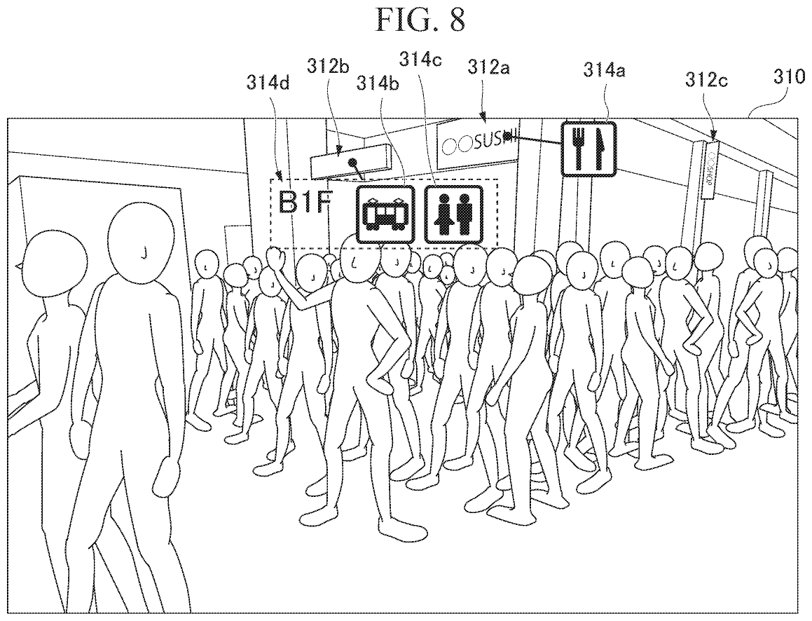

The display controller 124 controls the touch panel 140 such that the touch panel 140 displays a logo determined to be a display target overlaid on a through image. FIG. 8 is a diagram showing a state in which a logo is displayed by being overlaid on a through image. For example, it may be assumed that wording of “Sushi” is recognized at a position 312a through image analysis of the image analyzer 122. In this case, the logo acquirer 123 acquires a logo “Image002” associated with wording of “Sushi” and an event type ID “E002” with reference to the logo acquisition table 163. The logo acquirer 123 determines that the logo “Image002” is a logo displayed by being overlaid on a through image 310 because the acquired event type ID matches an event type ID of the setting information 162. The display controller 124 controls the touch panel 140 such that the acquired logo “Image002” is displayed by being overlaid on the through image 310. In the example of FIG. 8, a logo 314a of “Image002” is associated with the position 312a of the through image 310 and displayed by being overlaid thereon.

In addition, it is assumed that wording of “Railway,” “Toilet” and the like are recognized at a position 312b through image analysis of the image analyzer 122. In this case, the logo acquirer 123 acquires logos “Image001” and “Image003” corresponding to wording of “Railway” and “Toilet” and event type IDs “E001” and “E003” from the logo acquisition table 163. The logo acquirer 123 determines that the logos “Image001” and “Image003” are logos displayed by being overlaid on the through image 310 because the acquired event type IDs match event type IDs of the setting information 162. The display controller 124 controls the touch panel 140 such that the acquired logos “Image001” and “Image003” are displayed by being overlaid on the through image 310. In the example of FIG. 8, logos 314b and 314c of “Image001” and “Image003” are associated with the position 312b of the through image 310 and displayed by being overlaid thereon.

Further, when characters of “B1F” are recognized at a position 312b through the image analyzer 122, the display controller 124 may control the touch panel 140 such that character information 314d is associated with the position 312b of the through image 310 and displayed by being overlaid thereon.

Further, it is assumed that wording of “Shop” is recognized at a position 312c through image analysis of the image analyzer 122. In this case, the logo acquirer 123 acquires a logo “Image004” corresponding to wording of “Shop” and an event type ID “E004” from the logo acquisition table 163. The logo acquirer 123 determines that the logo “Image004 is not a logo displayed by being overlaid on the through image 310 because the acquired event type ID does not match any event type ID of the setting information 162. Accordingly, a logo is not displayed at the position 312c in the example of FIG. 8.

Accordingly, the terminal device 100 can display a logo associated with an event type set by a user. Therefore, the user can rapidly recognize the event type from the logo.

Further, when the touch panel 140 receives designation of any display position of the logos 314a to 314c displayed by being overlaid on the through image 310 through an operation such as tapping, for example, the detailed information requester 125 transmits an acquisition request for detailed information about the tapped logo to the server device 200. In this case, the detailed information requester 125 transmits, to the server device 200, a detailed information acquisition request including an event type ID corresponding to the tapped logo, the position of the terminal device 100 identified by the position identifier 150, and an imaging direction included in camera parameters of the imager 130.

The detailed information provider 220 of the server device 200 refers to the detailed information DB 241 on the basis of the detailed information acquisition request from the terminal device 100 and transmits detailed information corresponding to the detailed information acquisition request to the terminal device 100.

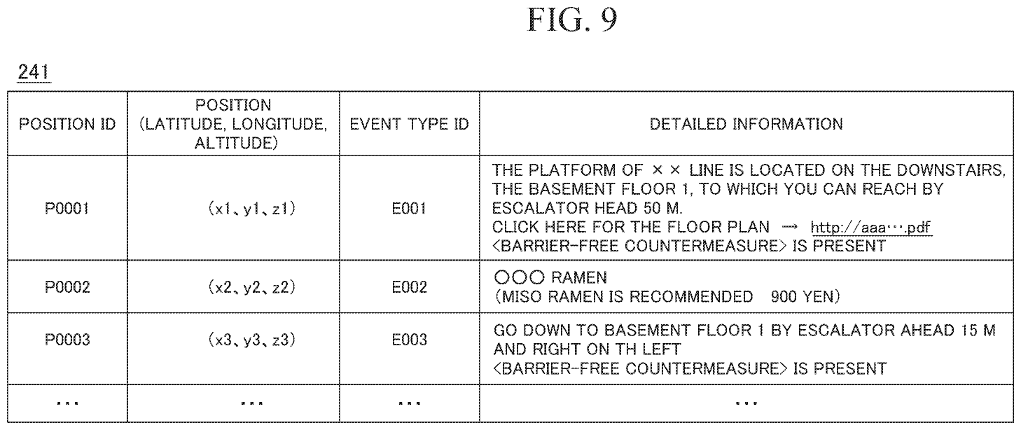

FIG. 9 is a diagram showing an example of details of the detailed information DB 241. In the detailed information DB 241, a position (e.g., latitude, longitude and altitude), an event type ID and detailed information are associated with a position ID that is identification information of a position of semantic information corresponding to the detailed information. Detailed information is information about description of semantic information associated with a position. In the first embodiment, information about a route from a current position to a train station, a floor plan, store names and the like corresponds to “detailed information.”

In addition, detailed information may include barrier-free countermeasure information. The barrier-free countermeasure information is information for identifying whether there are countermeasures such as facilities for supporting use, for example, for users such as aged persons and injured persons. For example, in the case of a toilet, “presence” of a barrier-free countermeasure is identified when a toilet that a user in a wheelchair can enter is installed.

The detailed information provider 220 acquires position IDs indicating positions at which the position of the detailed information DB 241 is included in an imaging direction based on the position of the terminal device 100 included in a detailed information acquisition request and a distance between the position of the terminal device 100 and the position of the detailed information DB 241 is equal to or less than a threshold value. Then, the detailed information provider 220 extracts a position ID having an event type ID matching an even type ID included in the detailed information acquisition request from the acquired position IDs and transmits detailed information associated with the extracted position ID to the terminal device 100. Accordingly, the detailed information requester 125 acquires detailed information corresponding to a logo designated through tapping of a user.

Next, the translation requester 126 determines whether detailed information acquired by the detailed information requester 125 needs to be translated. For example, the translation requester 126 may analyze the language of the detailed information and determine whether the analyzed language matches a translation language included in the setting information 162. When the analyzed language does not match the translation language included in the setting information 162, the translation requester 126 transmits a translation request including the detailed information and the translation language to the server device 200.

The translator 230 translates the detailed information into the designated translation language on the basis of the translation request from the terminal device 100. The translator 230 translates characters or sentences of the detailed information into characters or sentences of the translation language with reference to the translation dictionary 243 and transmits the translation result to the terminal device 100.

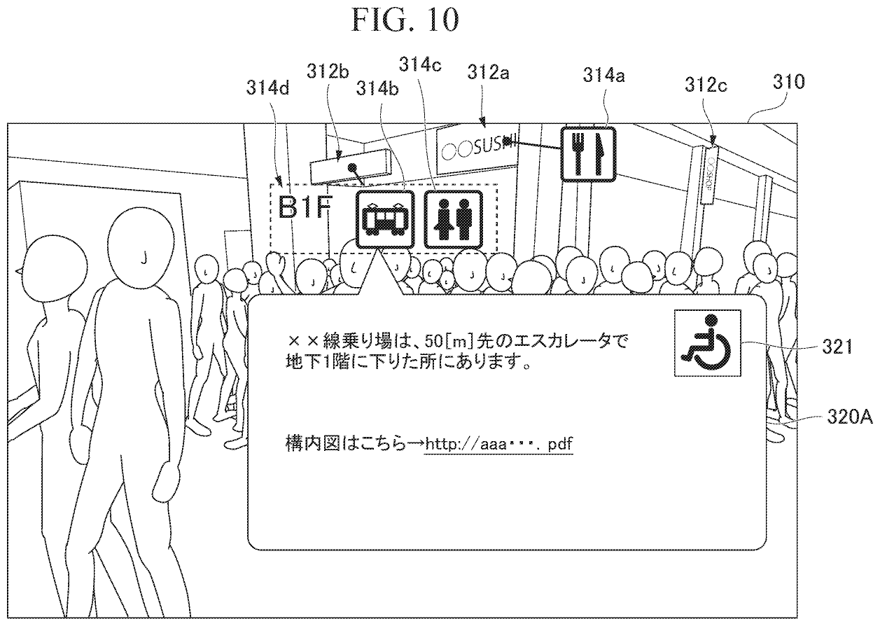

The display controller 124 controls the touch panel 140 such that it displays the detailed information obtained by the detailed information requester 125 or the translation result obtained by the translation requester 126. FIG. 10 is a diagram showing a state in which detailed information is displayed. For example, when a user taps a logo 314b, the display controller 124 controls the touch panel 140 such that it displays detailed information in a detailed information display area 320A. The detailed information is displayed on the touch panel 140 for example, when the translation language included in the setting information 162 is the same as the language of the detailed information, the translation language is not set in the setting information 162, or the translator 230 cannot translate the set translation language.

In addition, the display controller 124 may control the touch panel 140 such that it displays a logo 321 depending on presence or absence of a barrier-free countermeasure in the detailed information display area 320A on the basis of barrier-free countermeasure information included in the detailed information. Meanwhile, the logo 321 is stored, for example in the storage 160.

Furthermore, when characters of “http://aaa....pdf” indicating a floor plan displayed in the detailed information display area 320A are tapped through the touch panel 140, the display controller 124 may control the touch panel 140 such that is displays the floor plan at an access destination associated with the characters. In addition, when there is no detailed information with respect to the logo 314b, the display controller 124 may control the touch panel such that it displays information such as “no detailed information” in the detailed information display area 320A.

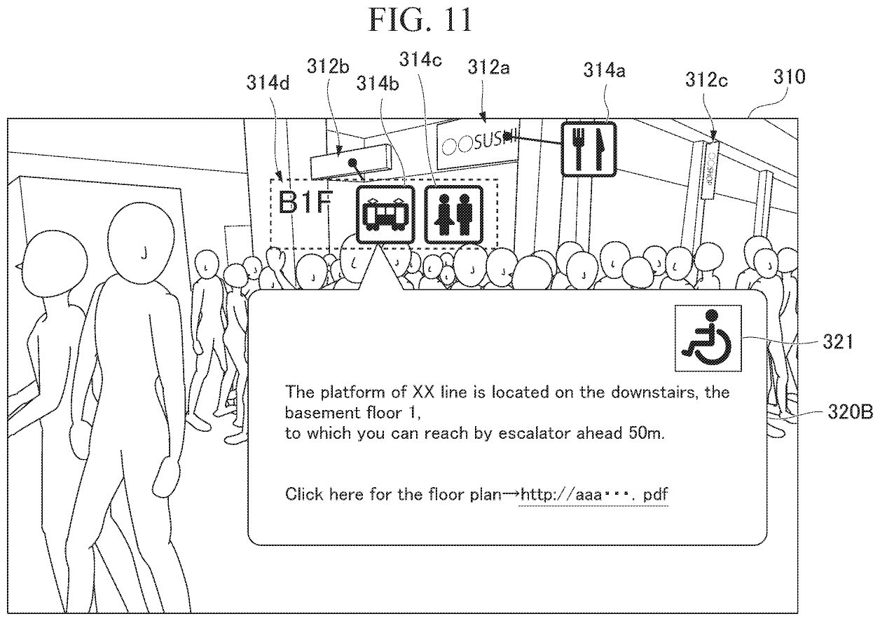

FIG. 11 is a diagram showing a state in which a translation result is displayed. For example, when a user taps the logo 314b, the display controller 124 controls the touch panel 140 such that it displays a translation result in a detailed information display area 320B. The translation result is displayed on the touch panel 140, for example, when the translation language included in the setting information 162 differs from the language of the detailed information or the translation result has been obtained from the translator 230. As shown in FIG. 10 and FIG. 11, the display controller 124 can present only information necessary for a user depending on the user.

Accordingly, the user reduces a burden during perception.

### [Processing Flow]

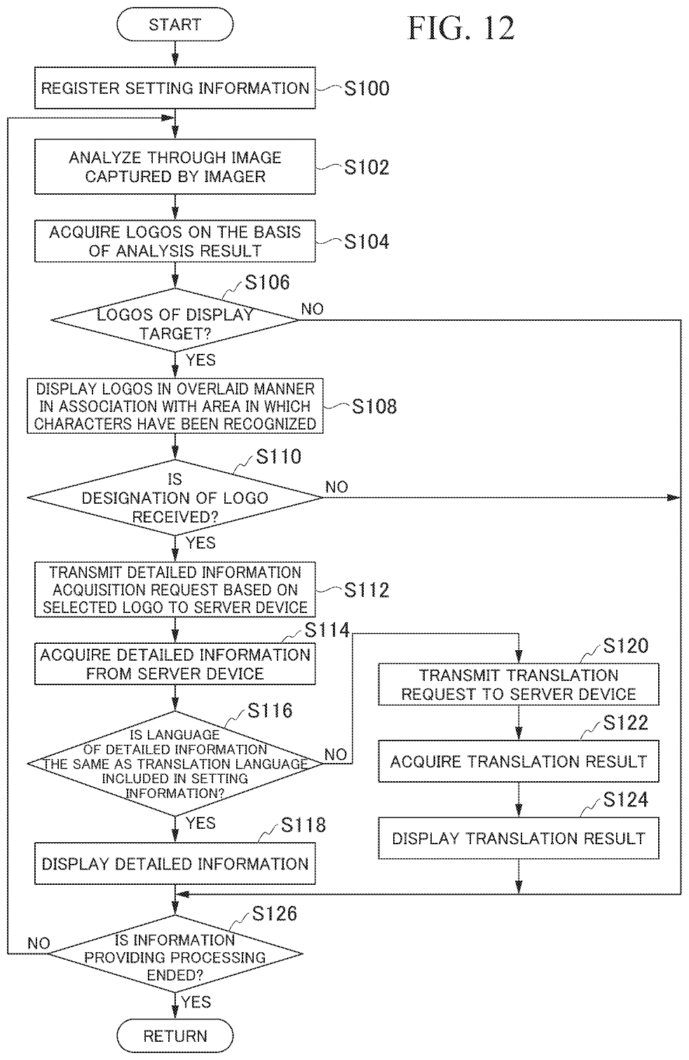

FIG. 12 is a flowchart showing an example of an information providing processing flow of the first embodiment. When the guide application 161 is started, the application executer 120 displays the setting screen 300 and registers setting information received through the setting screen (step S100). Further, when setting information has already been registered, processing of step S100 may not be performed.

Next, the application executer 120 analyzes a through image captured by the imager 130 (step S102) and acquires logos corresponding to an analysis result with reference to the logo acquisition table 163 stored in the storage 160 on the basis of the analysis result (step S104). Then, the application executer 120 determines whether the acquired logos are logos of a display target with reference to the setting information 162 (S106). When the acquired logos are the logos of the display target, the application executer 120 displays the logos overlaid on the through image in association with positions at which the analysis result has been obtained (step S108).

Then, the application executer 120 determines whether designation of a logo is received through tapping or the like of a user (step S110). When designation of the logo is received, the application executer 120 transmits detailed information acquisition request including the position and an imaging direction of the terminal device 100 and an event type ID of the designated logo to the server device 200 (step S112) and acquires detailed information based on the designated logo (step S114).

Next, the application executer 120 determines whether a language of the detailed information is the same as a translation language included in the setting information 162 (step S116). When the language of the detailed information is the same as the translation language included in the setting information, the application executer 120 controls the touch panel 140 such that it displays the detailed information (S118). On the other hand, when the language of the detailed information is not the same as the translation language included in the setting information, the application executer 120 transmits a translation request to the server device 200 (step S120) and acquires a translation result from the server device 200 (step S122). Then, the application executer 120 controls the touch panel 140 such that it displays the translation result (step S124).

After processing of step S118 or S124, the application executer 120 determines whether to end information providing processing when the logo acquired in step S106 is not the logo of the display target or designation of the logo is not received in step S110 (step S126). When the information providing processing is not ended, the application executer 120 returns to processing of step S104. On the other hand, when the information providing processing is ended, the application executer 120 ends processing of this flowchart.

As described above, according to the information providing system 1 of the first embodiment, it is possible to display a logo corresponding to an event designated by a user overlaid on a through image with respect to semantic information included in the through image and thus can reduce a burden during perception of the user. In addition, according to the first embodiment, it is possible to translate and display detailed information corresponding to a logo designated by a user such that the user can easily ascertain information necessary for the user.

### Second Embodiment

Next, a second embodiment will be described. In the second embodiment, when a destination is set by a user in advance in the terminal device 100, a route to the destination is displayed as detailed information of a logo related to the destination (e.g., a logo related to a transportation means) when the logo is designated.

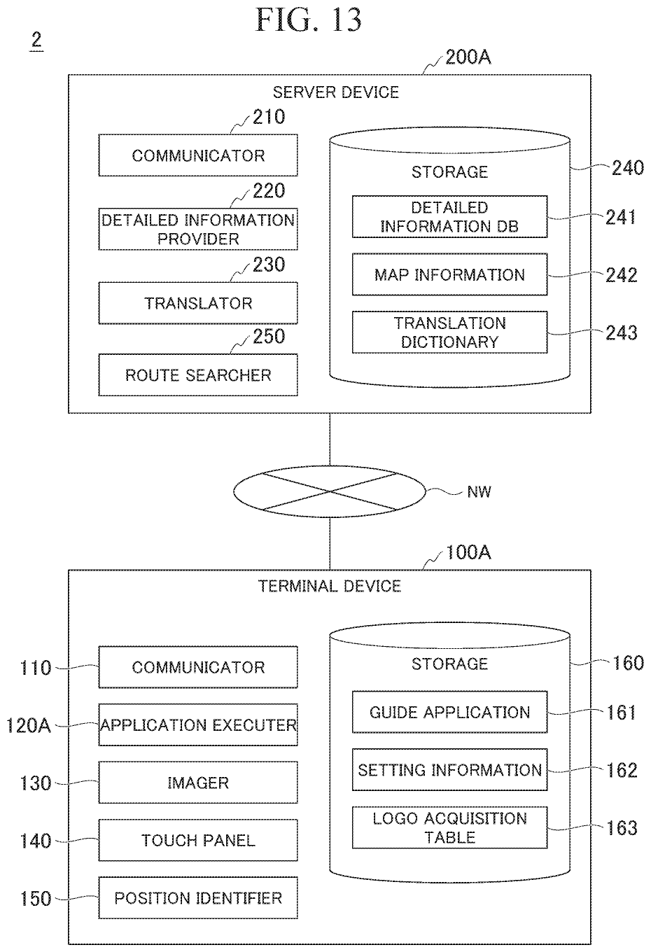

FIG. 13 is a diagram showing an example of a configuration of an information providing system 2 of the second embodiment. The information providing system 2 includes an application executer 120A in a terminal device 100A and includes a route searcher 250 in a server device 200A. Functions of other components are the same as those of the first embodiment.

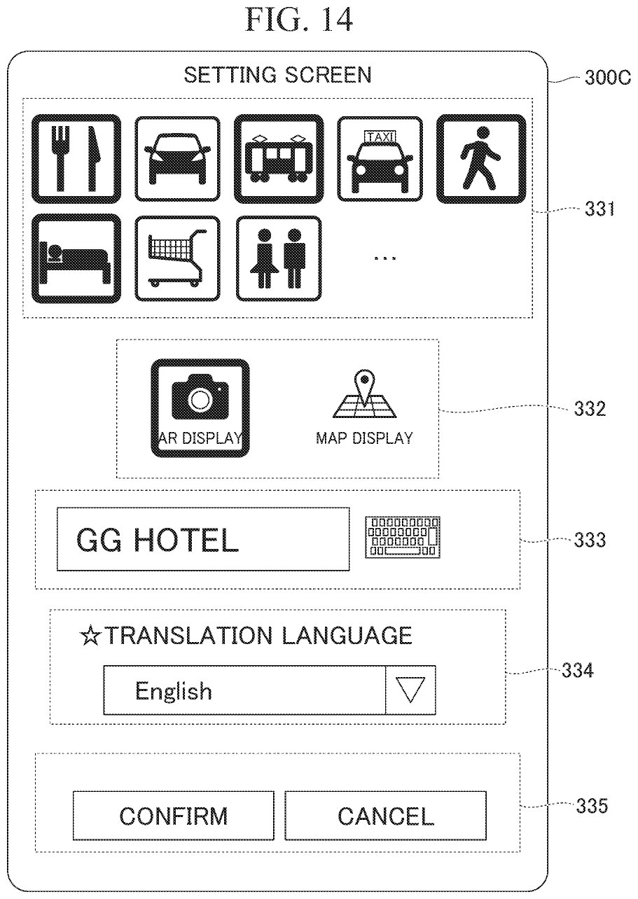

The application executer 120A controls the touch panel 140 such that it displays a setting screen through which a destination is set. FIG. 14 is a diagram showing an example of a setting screen 300C of the second embodiment. The setting screen 300C displays a logo display type selection area 331, a display image selection area 332, a destination setting area 333, a translation language selection area 334 and a confirmation operation area 335.

The logo display type selection area 331 is an area for selecting logos displayed on a through image acquired from the imager 130 and a map. A plurality of predetermined logos are displayed in the logo display type selection area 331. A user selects at least one logo corresponding to an event that the user wants to display from the logo display type selection area 331.

The display image selection area 332 is an area for selecting whether to display a logo overlaid on a through image acquired from the imager 130 or display the logo on a map acquired from the server device 200. The destination setting area 333 is an area for setting a destination by a user. The translation language selection area 334 and the confirmation operation area 335 correspond to, for example, the translation language selection area 302 and the confirmation operation area 303.

In the example of FIG. 14, logos related to a restaurant, a train, walking and accommodation are selected, augmented reality (AR) display for displaying a logo overlaid on a through image is selected, a GG hotel is input as a destination, and English is selected as a translation language.

The application executer 120A stores various types of information set through the setting screen 300C in the storage 160 as setting information 162. In addition, the application executer 120A analyzes semantic information included in a through image or a map acquired from the imager 130 and displays logos, which correspond to respective event types recognized as analysis results and set as a display target by the user, overlaid on the through image or the map.

Furthermore, when a logo displayed by being overlaid on the through image or the map is tapped, the application executer 120A transmits a detailed information acquisition request including an event type ID corresponding to the tapped logo, the position of the terminal device 100A identified by the position identifier 150, an imaging direction included in camera parameters of the imager 130, and a destination to the server device 200A.

When the detailed information acquisition request from the terminal device 100A includes a destination, the route searcher 250 of the server device 200A searches for a route to the destination from the current position with reference to the map information 242 on the basis of the position of the terminal device 100A and the destination. For example, when an event type ID included in the detailed information acquisition request is an ID corresponding to a train, the route searcher 250 may search for a shortest route and a travel time to the destination using a train as a transportation means. Further, the route searcher 250 may search for a shortest route and a travel time to the destination using other transportation means such as cars. Cars are vehicles traveling without a rail using power of a motor or the like distinguished from trains. Cars include two-wheeled, three-wheeled, four-wheeled vehicles, and the like. The route searcher 250 transmits route information including a route and a travel time acquired through route search to the terminal device 100.

The application executer 120A determines whether the route information needs to be translated with reference to the setting information 162 for the route information acquired from the server device 200A. When it is determined that the route information need not be translated, the display controller 124 controls the touch panel 140 such that it displays the route information acquired from the server device 200A overlaid on the through image or the map.

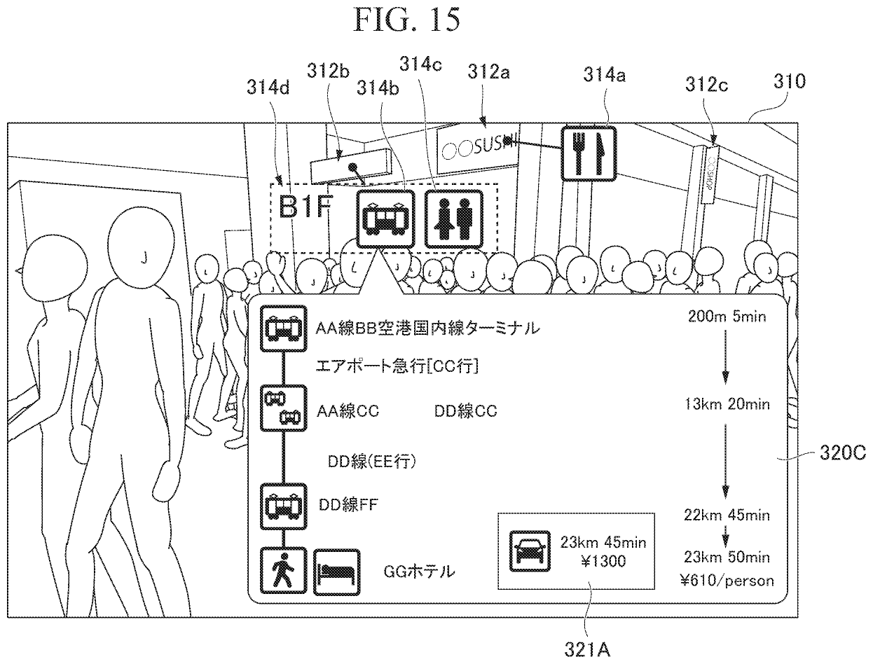

FIG. 15 is a diagram showing a display example of route information. In the example of FIG. 15, logos 314a to 314c corresponding to semantic information included in the through image 310 are displayed by being overlaid on the through image 310 as in FIG. 8. Here, when a user taps the logo 314b, the application executer 120A controls the touch panel 140 such that it displays route information corresponding to the logo 314b in a detailed information display area 320C.

In the example of FIG. 15, a route from a current position of the terminal device 100A to a destination using a train to “GG hotel” set in the destination setting area 333 of the setting screen 300C, a time until arrival and a fare are displayed in the detailed information display area 320C.

In addition, when it is determined that route information needs to be translated with respect to the route information acquired from the server device 200A, the application executer 120A transmits a translation request including the route information and a translation language to the server device 200A and receives a translation result from the server device 200A. The display controller 124 controls the touch panel 140 such that it displays the translation result corresponding to the route information acquired from the server device 200A overlaid on the through image or the map.

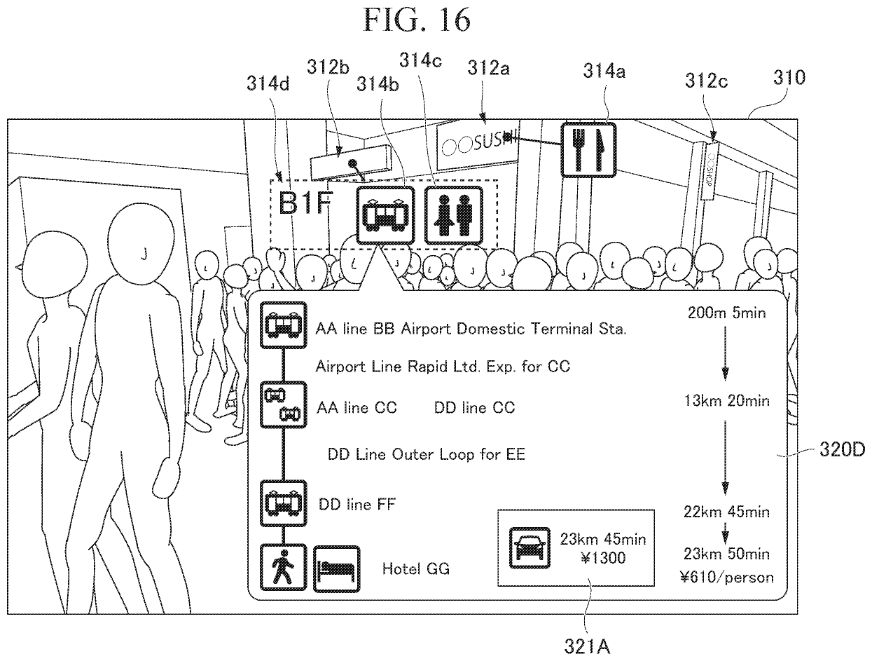

FIG. 16 is a diagram showing a display example of a translation result of route information. In the example of FIG. 16, the touch panel 140 is controlled such that it displays the translation result of the route information in a detailed information display area 320D. Further, the display controller 124 may display information 321A about a travel distance, a travel time and a fare when a car is used for a destination in the detailed information display area 320C and the detailed information display area 320D. Accordingly, a user can determine a route by comparing a plurality of routes.

As described above, according to the second embodiment, it is possible to provide detailed information depending on a destination to a user by displaying information on a route to the destination in addition to obtaining the same effects as those of the first embodiment.

### Third Embodiment

Next, a third embodiment will be described. In the third embodiment, the terminal device 100 displays logos corresponding to events on the basis of semantic information included in a through image, and when an operation of selecting a logo is received, displays a translation result of semantic information corresponding to the logo.

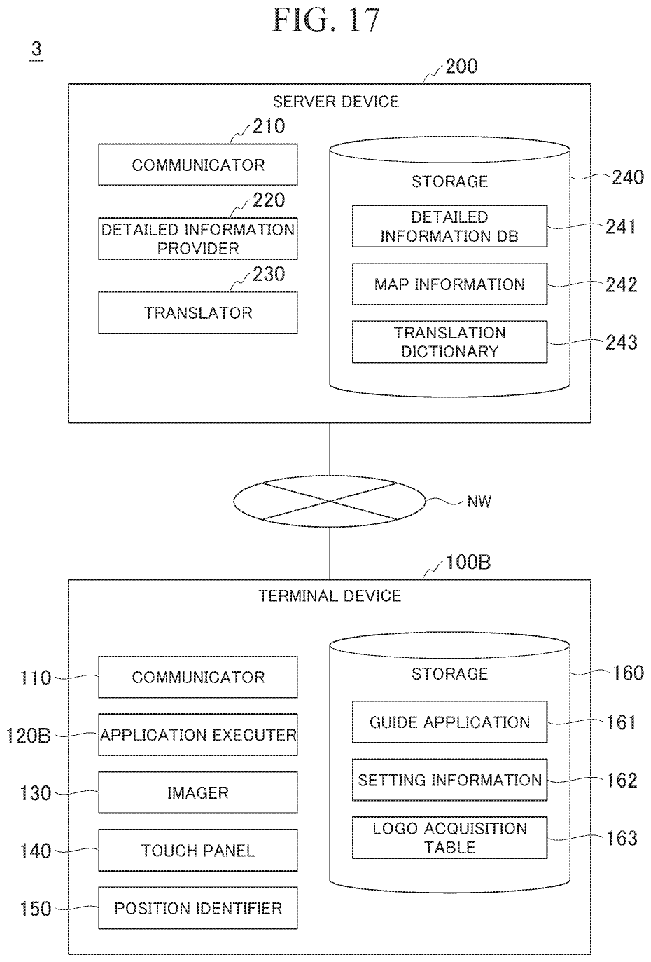

FIG. 17 is a diagram showing an example of a configuration of an information providing system 3 of the third embodiment. The information providing system 3 includes an application executer 120B and a translation application 164 in a terminal device 100B. Functions of other components are the same as those of the first embodiment.

The translation application 164 is, for example, an application program that is different from the guide application 161 in that detailed information is not displayed when a logo is selected by an operation of a user and a translation result of semantic information corresponding to the logo is displayed but includes the same functions as those of the guide application 161 with respect to other functions.

For example, the terminal device 100B may start the translation application 164 when an input operation from a user is received for an image for starting the translation application 164 displayed on the touch panel 140. Accordingly, the application executer 120B starts to operate.

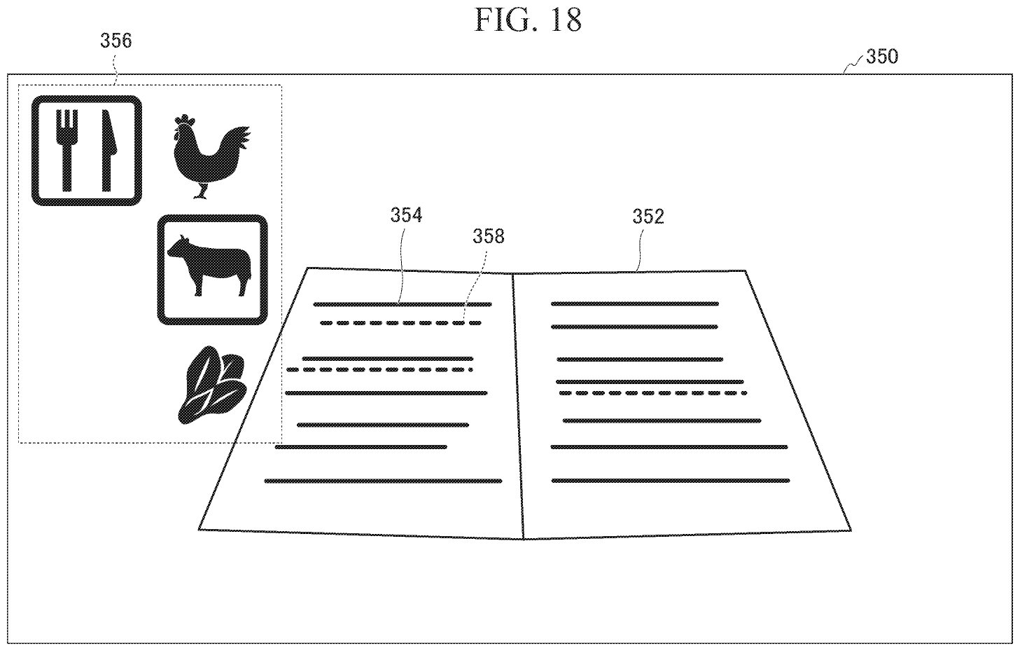

FIG. 18 is a diagram showing an example of a through image 350 obtained by capturing a menu of dishes 352 of a restaurant by the terminal device 100B. The application executer 120B displays the through image 350 from the imager 130, analyzes semantic information 354 included in the through image 350, acquires a logo corresponding to an event type associated with the semantic information 354 from the logo acquisition table 163 and controls the touch panel 140 such that it displays the logo overlaid on the through image 350.

In the example of FIG. 18, the application executer 120B controls the touch panel 140 such that it displays logos corresponding to event types associated with the semantic information 354 in a logo display area 356 on the left side of a display area of the through image 350. Logos of chicken dish, meat dish, vegetable dish and the like acquired from the semantic information 354 included in the menu of dishes 352 are displayed on the through image 350 in the logo display area 356. Further, logos displayed in the logo display area 356 may be set by a user through a setting screen or the like. In addition, the application executer 120B combines at least a part of the through image with positional information of the terminal device 100B and the like, transmits the combined information to an external device, and acquires information of a plurality of attributes included in the through image analyzed by the external device. Then, the application executer 120B may extract a logo to be displayed in the logo display area 356 from the acquired information of the plurality of attributes on the basis of setting information from the user.

Here, it is assumed that a logo of a meat dish from among logos displayed by the user is tapped. In this case, the application executer 120B extracts menu details corresponding to the meat dish from the semantic information 354 and determines whether the language of the menu details matches a translation language set in the setting information 162. When the language of the menu details does not match the translation language, the application executer 120B transmits a translation request including the menu details and the translation language to the server device 200 and controls the touch panel 140 such that it displays a translation result 358 received from the server device 200 overlaid on the through image 350. Further, the application executer 120B controls the touch panel 140 such that it displays the translation result 358 overlaid at a position (e.g., below a display position of the menu details) associated with the display position of the menu details.

As described above, according to the third embodiment, it is possible to present translation information of semantic information necessary for a user to the user. Accordingly, the user can obtain information that the user wants to know without missing it. In addition, it is possible to reduce a burden during perception of the user because only semantic information corresponding to a designated event type is translated and displayed.

### Fourth Embodiment

Next, a fourth embodiment will be described. In the fourth embodiment, a part in which semantic information related to an event designated using a logo is displayed is emphasized and displayed among semantic information included in a through image acquired from the imager 130 of the terminal device 100. Furthermore, in the fourth embodiment, a translation result of emphasized and displayed semantic information is displayed. Functions of components of the fourth embodiment are the same as those of the third embodiment.

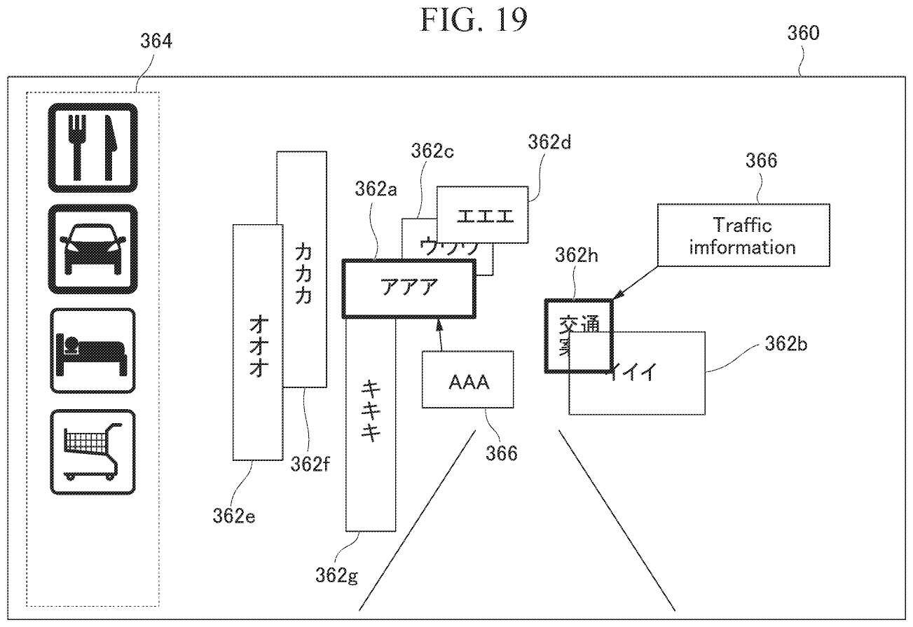

FIG. 19 is a diagram showing an example of a through image 360 obtained by capturing signboards from a car traveling on a road. A plurality of signboards 362a to 362h in a real space are displayed in the through image 360. The application executer 120B analyzes semantic information of the signboards 362a to 362h, identifies logos corresponding to event types of the semantic information from an analysis result and controls the touch panel 140 such that it displays the identified logos overlaid on the through image 360.

In the example of FIG. 19, the application executer 120B controls the touch panel 140 such that it displays logos corresponding to event types of the semantic information of the signboards 362a to 362h in a logo display area 364 provided on the left side of a display area of the through image 360.

Here, it is assumed that a user taps logos corresponding to a restaurant and a car. In this case, the application executer 120B emphasizes and displays parts including semantic information corresponding to the logos tapped by the user. In the example of FIG. 19, the outlines of the signboards 362a and 362h are emphasize and displayed.

Furthermore, when the language of the semantic information corresponding to the logos is different from a translation language of the setting information 162, the application executer 120B transmits a translation request including the semantic information and the translation language to the server device 200 and controls the touch panel 140 such that it displays a translation result 366 received from the server device 200 in association with the semantic information of the translation targets.

Moreover, in the fourth embodiment, when semantic information described in the signboard 362 is guide information of stores such as restaurants and the like and facilities such as theme parks and the like, the application executer 120 may analyze text in the guide information to set a destination using names, addresses and the like, acquire a route from the current position to the destination from the server device 200 and control the touch panel 140 such that it displays the acquired route information on a screen. Further, the application executer 120 may transmit route information acquired from the server device 200 to a navigation device mounted in a car in which a user is riding such that the navigation device performs route guidance.

As described above, according to the fourth embodiment, a part in which semantic information corresponding to an event type set by a user is displayed is emphasized and displayed and thus the user can easily ascertain a position at which semantic information that the user wants to know is displayed. Accordingly, a burden during perception of the user can be reduced. Furthermore, according to the fourth embodiment, a translation result corresponding to emphasized and displayed semantic information is displayed and thus a user can easily understand details of the emphasized and displayed semantic information. Meanwhile, the above-described first to fourth embodiments may be combined with some or all of other embodiments.

### Application Example

Next, an application example of the aforementioned embodiments will be described. Here, a structure in which the functions in the server device 200 of the above-described information providing systems are provided by a service provider and the service provider receives incentives for information provision from other providers, a business owner and the like will be described.

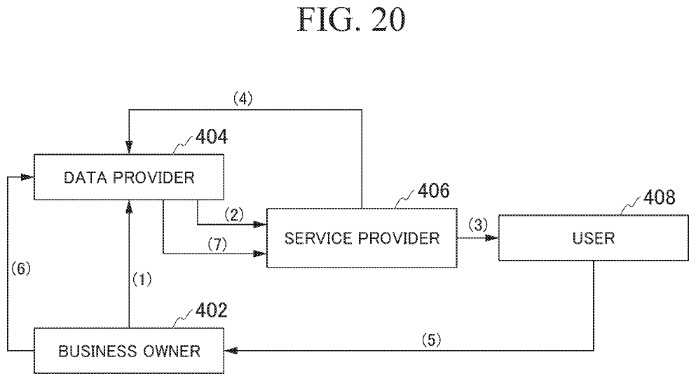

FIG. 20 is a diagram showing an example of a structure for distributing incentives in a system to which an information providing system is applied. A business owner 402 is, for example, a manager that manages a store such as a restaurant or manages a facility such as a theme park. A data provider 404 generates data such as the detailed information DB 241, the map information 242 and the translation dictionary 243 to be managed by a service provider 406 and provides the data to the service provider 406.

The service provider 406 is a manager that manages the server device 200 in the information providing systems 1 to 3. A user 408 is an owner of the terminal device 100 in the information providing systems 1 to 3 and a user of the information providing systems 1 to 3.

In the example of FIG. 20, first, the business owner 402 provides, for example, maps around a store or a facility managed thereby, guide information about products or services sold thereby, trademarks, names, a store signboard image, and the like to the data provider 404. The data provider 404 generates map information 242 and detailed information DB 241 from the maps and the guide information provided from the business owner 402. In addition, the data provider 404 generates or updates a translation dictionary 243 in association with the generated detailed information DB 241. Further, the data provider 404 provides the generated map information 242, detailed information DB 241 and translation dictionary 243 to the service provider 406.

The service provider 406 provides a translation result based on the detailed information DB 241 and the translation dictionary 243 provided by the data provider 404, a route information based on the map information 242, and the like in response to a detailed information acquisition request, a translation request and a route search request from the terminal device 100 of the user 408. Further, the service provider 406 provides a service use result (history information) of the user to the data provider.

When the user 408 uses the store or the facility managed by the business owner 402 on the basis of information acquired from the service provider 406, the business owner 402 provides the usage result to the data provider 404.

For example, the data provider 404 may provide an incentive such as a compensation based on sales of the business owner 402 to the service provider 406 which has provided the information provision service to the user 408.

According to the above-described application example, the service provider 406 that is a manager of the server device 200 can obtain profit for information provision.

While forms for embodying the present invention have been described using embodiments, the present invention is not limited to these embodiments and various modifications and substitutions can be made without departing from the spirit or scope of the present invention.

What is claim is:

1.-9. (canceled)

10. An information providing system comprising:
an imager;
a display which displays an image captured by the imager;
an identifier which analyzes the image captured by the imager and identifies types and positions of objects indicated by semantic information included in the image; and
a display controller which causes the display to display an image corresponding to an object type predetermined by a user from among the object types identified by the identifier such that the image is selectively overlaid at the positions.

11. The information providing system according to claim 10, further comprising a receiver which receives an input operation of a user,
wherein the display controller causes the display to display an image corresponding to an object type input to the receiver from among the object types identified by the identifier.

12. The information providing system according to claim 10, wherein the image corresponding to the object type is an image representing the object type without depending on text information.

13. The information providing system according to claim 10, wherein the display controller causes the display to display the image corresponding to the predetermined object type in association with a position at which the semantic information is displayed.

14. The information providing system according to claim 10, further comprising a receiver which receives an input operation of a user,
wherein the display controller controls the display such that the display displays detailed information of an object identified by the identifier according to an operation performed through the receiver in response to display of the image through the display.

15. The information providing system according to claim 14, wherein the display controller translates the detailed information of the object identified by the identifier into a language set by a user and causes the display to display the translated information.

16. The information providing system according to claim 10, wherein the display controller causes the display to emphasize and display a part of the image corresponding to an object type set by the user.

17. An information providing method comprising, using a computer:
displaying an image captured by an imager on a display;
analyzing the image captured by the imager and identifying types and positions of objects indicated by semantic information included in the image; and
displaying, on the display, an image corresponding to an object type predetermined by a user from among the identified object types such that the image is selectively overlaid at the positions.

18. A non-transitory computer-readable storage medium that stores a program to be executed by a computer to perform at least:
to cause a display to display an image captured by an imager;
to analyze the image captured by the imager and identify types and positions of objects indicated by semantic information included in the image; and
to cause the display to display an image corresponding to an object type predetermined by a user from among the identified object types such that the image is selectively overlaid at the positions.
